(19) United States
(12) Patent Application Publication
(10) Pub. No.: US 2003/0227108 A1
(43) Pub. Date: Dec. 11, 2003

(54) Thick composite continuous molding process

(76) Inventor: C. Albert Okerson, Franklin, TN (US)

Correspondence Address: Richard S. Myers, Jr., Stites & Harbison PLLC, Suite 1800, 424 Church Street, Nashville, TN, 37219-2376, US

(21) Appl. No.: 10/382,484

(22) Filed: Mar. 6, 2003

Related U.S. Application Data
(60) Provisional application No. 60/362,133, filed on Mar. 6, 2002.

(51) Int. Cl. B29C 45/06; B29C 47/00; B29C 45/40; B29C 45/16

(52) U.S. Cl. 264/255; 425/435; 425/382.3; 264/297.2; 264/297.6; 264/328.19; 264/328.18; 264/334

(57) ABSTRACT

A method for producing an elongated composite that comprises the use of a cycleable molding apparatus that has (i) at least one extruder, (ii) a mold assembly carousel having an axis, inner circumference, outer circumference, and being rotateable about its axis in a substantial vertical plane and being capable of indexing a mold assembly to an injection station, cooling station, and removal station, and (iii) at least one mold assembly engaged with the outer circumference of the mold assembly carousel. Moldable resin is injected a mold assembly located about the axis of the mold assembly carousel. The mold assembly is rotated to a cooling station or cooling area and later rotated to a composite removal station, where the composite is ejected from the mold assembly.

### PRIORITY

The present invention claims priority to U.S. Patent Application No. 60/362,133, filed on Mar. 6, 2002, now abandoned, the contents of which are incorporated herein by reference in their entirety.

### FIELD OF THE INVENTION

This invention relates to the field of continuous molding apparatus for the purpose of manufacturing thick composite products such as railroad cross ties, short marine pilings, posts, highway guard rails, and decking and fence lumber.

This invention relates in general to molding equipment and, more particularly, to an automatic continuously cycleable molding technique and system which is ideally suited for the manufacture of large composite products such as railroad cross ties, posts, lumber and marine pilings.

### BACKGROUND OF THE INVENTION

The use of polymeric materials and composites has steadily increased in recent years because of many beneficial properties. For example, the use of plastic or polymeric materials is the combination of light weight and high strength. Furthermore, polymeric materials do not readily biodegrade.

As stated in U.S. Pat. No. 5,886,078, incorporated herein by reference, wood based railroad ties are particularly susceptible to wear and deterioration due to processes such as erosion caused by weather such as freezing cycles, insect attack, and water penetration.

Traditionally, molds for polymeric materials are manually moved in and out of position for filling. The molds are typically manually immersed in water bath for cooling and the product is extracted from the molds manually. This process is slow and expensive, with varying results.

With the advent of restrictions on CCA (copper, cliromates and arsenic) wood products, and now pending restrictions on creosote-treated wood products, it is believed that the composite manufacturing system is a valuable technology.

Other traditional molding processes utilize molds which are jacketed with cooling manifolds to pump cooling water or ethylene glycol to provide the heat transfer from the molded part. However, this concept does not work well with products with thick cross sections due to the inability to remove the process heat in a practical length of time. The molded part shrinks as it cools, and releases from the cooling surface of the mold. To achieve the necessary transfer of heat in a reasonable time frame, it is necessary to completely immerse the mold and the molded part in the cooling media, in this case a water bath which is preferably temperature controlled to the desired operation temperature.

Large composite products such as railroad crossties, posts, lumber and marine pilings have traditionally been molded in individual molds that are positioned manually. After each mold is manually positioned and connected to the extruder nozzle, the extruder is started and the mold is filled. At which time the extruder is stopped and the mold is manually disconnected and manually replaced with another empty mold. This mold changing cycle is manually repeated for the entire production run:

The following references, all of which are incorporated herein by reference, are cited to illustrate the general state of the art with respect to several features of the present invention and the general background of the art.

U.S. Pat. Documents

| Patent Number | Issue Date | Inventor |
|---|---|---|
| 1,819,277 | Aug. 18, 1931 | Carpenter |
| 2,026,439 | Dec. 31, 1935 | Sanial |
| 2,375,955 | May 15, 1945 | Smith |
| 2,494,212 | Jan. 10, 1950 | Spriggs, et al. |
| 2,665,648 | Jan. 12, 1954 | Vogt |
| 2,923,034 | February 1960 | Dickie, et al. |
| 3,342,913 | Sep. 19, 1967 | Engel |
| 3,425,092 | February 1969 | Taga |
| 3,479,429 | November 1969 | Morshauser, et al. |
| 3,500,541 | Mar. 17, 1970 | Hammerlund |
| 3,590,109 | Jun. 29, 1971 | Doleman |
| 3,677,673 | Jul. 18, 1972 | Shapiro |
| 3,774,811 | Nov. 27, 1973 | Staerman |
| 3,824,062 | Jul. 16, 1974 | Farrell |
| 3,833,329 | Jan. 15, 1973 | Ulmachneider |
| 3,993,787 | Nov. 23, 1976 | Nakabayashi |
| 4,128,384 | Dec. 5, 1978 | Albright |
| 4,160,761 | Jul. 10, 1979 | Prusinski et al. |
| 4,187,352 | Mar. 7, 1978 | Klobbie |
| 4,877,387 | Oct. 31, 1989 | Fierkens, et al. |
| 5,055,350 | Oct. 8, 1991 | Neefe |
| 5,075,051 | Dec. 24, 1991 | Ito, et al. |
| 5,320,511 | Jun. 14, 1994 | Woerner |
| 5,368,793 | Nov. 29, 1994 | Lau |
| 5,609,295 | Mar. 11, 1997 | Richards |
| 5,799,870 | Sep. 1, 1998 | Bayer |
| 6,153,293 | Nov. 28, 2000 | Dahl |

### ARTICLES AND PUBLICATIONS

Okerson, A./Mack, M., “Thick Composite Extrusion Process”, ANTEC 2002, Annual Technical Conference, Society of Plastic Engineers, May 5-9, 2002.

Rosenzweig, M., “New Materials Spur Product Development”, Modem Plastics, July 2002.

Cover Story, “PE Shows Its Versatility With Railroad Tie Application”, Modem Plastics, August 2002.

Rosenzweig, M., “Plastic Railway Ties Build A track Record”, in Modern Plastics, November 2002

With respect to the patents listed above, U.S. Pat. No. 3,500,541 discloses a device to manufacture butter by utilizing a ram to force the material through a die plate. Length sensing devices are used to determine the size of cut patties, etc.

U.S. Pat. No. 3,824,062 discloses a molding apparatus comprising molds which are moved along a predetermined track on movable carriage platens.

U.S. Pat. No. 3,833,329 discloses an injection molding apparatus which functions with a plurality of molds rotating in a horizontal plane. Each mold is contained within a clamping mechanism and is filled with an intermittent injection from an injection chamber adjacent to each mold. The injection chambers are filled through a manifold system from the thermoplastic extruder.

U.S. Pat. No. 4,128,384 discloses a molding apparatus employing multi-cavity molds, which are passed through inspection, locking, preheating orientation molding, second orientation, curing, unlocking, insert loading, and product ejection stations.

U.S. Pat. No. 4,187,352 discloses a molding system to produce plastic products, which uses an extruder without a screen member or nozzle. In this technique the extruder must be stopped between each molded article. Each mold is open ended with on connected to the outlet of the extruder.

U.S. Pat. No. 4,877,387 discloses an automatic continuously cyclable molding system wherein a plurality of mold sets are transported in predetermined timed cycles through a series of work stations wherein the various molding, curing and workpiece handling operations are accomplished, and wherein the mold sets are recirculatingly moved through the system for repeated usage.

U.S. Pat. No. 5,075,051 discloses a molding apparatus which transports plural molds in succession along a guide through a temperature elevating step, and injection molding step, pressurized cooling step and a molded article removing step. The apparatus is provided with plural cooling presses for the pressurized cooling step and so constructed as to prevent the stagnation in the transfer of the molds according to the molding conditions and the number of molds.

U.S. Pat. No. 5,320,511 discloses a rotatable disk containing molds, which are filled by injection molding machines. The molds are extended radially into clamping mechanisms to close the molds during the injection process.

U.S. Pat. No. 5,368,793 discloses an automatic molding system, which uses non attached molds that are sequentially processed. Each mold is moved through storage, preheating, molding curing, disassembly, dismantling, reassembly, cleaning then back to the storage station.

U.S. Pat. No. 5,609,295 discloses a product composition which would be suited to use this technology in the production of railroad crossties and other composite products if a reinforcing member is not used.

U.S. Pat. No. 5,799,870 discloses a product composition which would be ideally suited to use this technology in the production of railroad crossties or other composite products.

U.S. Pat. No. 6,153,293 discloses a technique to form a foam core to the technique shown in this patent. By injecting the core material from a dedicated extruder the foam density call be more accurately controlled. This technique can also use different thermoplastic materials and different melt viscosities from the material used for the outer shell, thereby reducing manufacturing costs.

### BRIEF DESCRIPTION AND OBJECTS OF THE PRESENT INVENTION

One object of the present invention is to provide a new and improved molding apparatus and method of the type that is particularly useful for producing relatively thick plastic articles and/or articles where cooling by a water bath or other cooling media is acceptable or preferred.

Another object of the present invention is to provide a method and apparatus for extruding thick composites at higher production rates.

These and other objects of the present invention are apparent from a reading of this disclosure including this application and the drawing sheets.

An embodiment of the present invention is a method for producing an elongated composite. This method comprises providing a moldable thermoplastic resin composition and providing a cycleable molding apparatus of the present invention. In this embodiment, the apparatus comprises at least one extruder, a mold assembly carousel having an axis, inner, circumference, outer circumference, and being rotatable around its axis in a substantial vertical plane and being capable of indexing a mold assembly to an injection station, cooling station, and removal station. This carousel comprises at least one mold assembly around its outer circumference. The moldable resin thermoplastic composition is injected into a mold assembly by an extruder at an injection station (injection area). This injection station is located about the axis of the mold assembly carousel, preferably about the outer circumference of the mold assembly. Once filled, the mold assembly carousel rotates, delivering the injection-filled mold assembly to a cooling station (cooling area). Once at the cooling station, the injection-filled mold assembly cools, or cures, to form an elongated composite. Finally, the mold assembly continues rotating, delivering the composite to a composite removal station (removal area) where the composite is ejected from the mold assembly.

Another embodiment of the present invention is an injection molding apparatus that comprises at least one extruder, a mold assembly carousel, and at least one mold assembly engaged with the outer circumference of the mold assembly carousel, and the water bath that submerses the mold assembly for a period of time. A submersion in the water bath causes the moldable resin composition to solidify into a solidified extrusion material. This solidified extrusion material may in the form of various composites including, a railroad cross tie.

Another embodiment of the present invention is an injection molding apparatus that comprises a rotatable member with an axis and a periphery. A plurality of mold assemblies disposed around the periphery of the rotatable member, at least one resin melt injection extruder with at least one injection nozzle that is receivable by mold assembly, and a water bath that intersects the mold assemblies during a rotating cycle of the rotatable member. Finally, the injection molding apparatus of the present invention includes an injection device that removes the solidified extruded material.

In another, preferred embodiment of the present invention, the method comprises providing an extruder to plasticate and mix the thermoplastic resins and fillers. As the thermoplastic resins are plasticated and the fillers are mixed into the thermoplastic resins, the fused mass is continuously pumped out of the extruder via the internal pressure of the extrusion process. In this embodiment, as the fused thermoplastic mass is continuously pumped out of the extruder, it is fed either into the enclosed mold or directed to an accumulator via the appropriate valving.

The accumulator, which may attached to the output of an extruder, has flow valves to divert the extruder output between the accumulator and the output nozzle, which is connected to the mold inlet. When the empty mold is correctly indexed or moved to the proper filling position, the accumulator discharges its contents into tile empty mold. This flow from the accumulator is supplemented with the continuous discharge of thermoplastic material from the extruder.

Molds, which conform to the shape and dimensions of the end product, are mounted around the circumference of a large carousel, which is a large, upright wheel indexing on a fixed axle. The carousel of molds has a standard drive mechanism with a CPU-controlled motor to index the molds from the filling position through a water bath to the product removal position. A preferred design consists of 26 molds. In actual practice it could have more, or fewer, molds. This number of molds required would depend on the production rate desired and the size of the finished product. Preferably, the assembly will have at least 10 molds. The molds along the carousel may be designed to produce the same or different products.

A pneumatic cylinder, fitted with a temperature controlled platen on the end of its extended plunger, which traverses longitudinally inside the mold to provide the necessary back pressure during the mold filling sequence.

A Sump of sufficient size and depth to immerse or partially immerse the carousel and the filled molds into the temperature controlled water or other cooling media is preferred. Preferably the molds in the approaching and in the immediate filling and removal positions are above the cooling media level.

A product removal position is required on the carousel. A preferred embodiment is a pneumatic, or hydraulic cylinder to push the product out of a mold as the preceding mold is filled with thermoplastic material. A roller conveyor may transport the finished product away from the molding operation.

Optionally, the following process may be used to fill a mold with thermoplastic material: (i) A valve that controls the extruder discharge diverts the flow of thermoplastic material into an accumulator. (ii) The mold-filling nozzle disconnects from a mold inlet port and retracts, or is otherwise moved, to provide clearance for the mold to index out of the mold filling position. (iii) A temperature controlled platen is fully retracted from the mold by a pneumatic cylinder. (iv) The carousel indexes to place the next empty mold, into the correct filling position. (v) The fill nozzle extends and connects with this new empty mold inlet port. (vi) The temperature controlled platen is fully extended into the empty mold by the pneumatic cylinder. (vii) The discharge valve, on the outlet of the accumulator, diverts the flow of thermoplastic material from the accumulator and extruder into the empty mold. (viii) As the empty mold is filled with thermoplastic material, the temperature controlled platen, on the end of the extended pneumatic cylinder, is forced to retract as the force of the thermoplastic material entering the mold overcomes the controlled pressure in the pneumatic cylinder. This temperature controlled platen provides the necessary backpressure to ensure a completely filled mold, without significant voids or deformities in the finished molded product. It also cools, embosses, and solidifies the advancing end of the product as it fills the mold. With the product end solidified it will not require a supporting mechanism during the remainder of the cooling process. (xi) Preferably, to provide a smooth cycle, each time the carousel indexes between filling cycles, a hot, filled, mold is immersed into the water bath and a filled and cooled mold is raised out of the water.

### BRIEF DESCRIPTION OF THE DRAWINGS

FIG. 1 shows an end view of an embodiment of a cycleable molding apparatus of the present invention.

FIG. 2 shows a top view of a preferred embodiment of a cycleable molding apparatus of the present invention.

FIG. 3 shows a top view of a preferred embodiment of the cycleable molding apparatus of tile present invention. This embodiment has two extruded feeding the molds.

FIG. 4 shows embodiments of the elongated composites produced by the method and apparatus of the present invention.

FIG. 5 demonstrates the injection station, cooling station and removal station of a process of the present invention.

FIG. 6 shows an embodiment of the present invention where the mold assemblies are extendable from the central axis to be indexed to the injection or removal station.

FIG. 7 shows the embodiment of FIG. 6, with the mold assembly in a retracted or folded position.

### DETAILED DESCRIPTION OF THE INVENTION

As stated above, an embodiment of the present invention is a method of producing an elongated composite. This method includes injecting a moldable resin composition into a mold assembly. Using the cycleable molding apparatus of the present invention, the mold assembly is rotated to a cooling station where the injected resin composition is cooled or cured. After cooling, the mold assembly is further rotated to a composite removal station. Here, the cooled solidified composite is rejected from the cycleable molding apparatus.

Preferably, the mold assembly carousel is in substantially constant rotation about its axis during the method of the present invention. This embodiment helps to provide a continuous molding operation. Furthermore, the extruder preferably delivers a substantially constant melt stream during the method of the present invention. In certain embodiments, the extruder may comprise an accumulator to receive a melt stream when the injection-filled mold assembly is being indexed to the cooling station. When an empty mold assembly is indexed to the injection station, the melt stream may be released from the accumulator to fill the mold assembly. Alternatively, the mold assembly carousel could rotate intermittently during a molding operation, allowng the extrusion or removal process to start or stop when an empty mold assembly is indexed into the proper position at the injection or removal stations.

The molding apparatus of the present invention further comprises a water bath as the cooling station. Preferably, at least part of the mold assembly carousel is submerged in the water bath. The mold assembly should be submersed in the water bath for a period long enough to substantially cool and folds the elongated composite. For a typical railroad cross tie, this period will range from about 60 minutes to about 180 minutes. Of course, the required cooling time would be greater for thicker composites and would be longer for thicker composites and shorter for thinner composites. Additionally, the cooling time would depend on the temperature of the cooling bath. Where the cooling bath is maintained at a colder temperature, a shorter required cooling time would result. Once an injection-filled mold assembly completes the cycle, it is removed from the apparatus by an ejection device. The nature of the ejection device may vary. Preferably, the ejection device is an extendable and retractable pneumatic cylinder that pushes the composite out of the mold.

In a preferred embodiment and a best mode for practicing the present invention, a molding system comprised of an extruder, which continuously supplies a fused thermoplastic melt through an adapter, which is connected to a melt accumulator inlet. The accumulator may be vented through a melt valve and a nozzle orifice into a mold. In this embodiment, the molds are ones of a multiple quantity, which are attached to a carousel device. Preferably the carousel holds about 26 molds, although more or less is possible. The molds are attached to the carousel device in a manner which permits them to rotate on an axle, as in a cylindrical plane. The carousel device is mounted in a reservoir of temperature controlled cooling media. In this embodiment, typically only three to six molds are above the water level at any time during operation of the molding system. However, in certain embodiments where the molds are extended out of the water bath for injection or removal, there will be one to two molds above the water level.

When a mold is aligned and connected to the outlet of the nozzle to form a continuous flow path, a temperature controlled platen may be used and extended into the opposing end of the mold by means of an air cylinder, as the mold is drawn tightly to the nozzle outlet. The melt valve is then opened and the mold is filled with thermoplastic melt.

The temperature controlled platen may alternately be positioned in the mold by using a hydraulic cylinder or mechanical lead screw mechanism. In certain embodiments, a hydraulic pump, which pumps hydraulic fluid from a reservoir to the hydraulic cylinder, to extend the temperature controlled platen into the mold cavity, may power a hydraulic cylinder. A lead screw would have the temperature controlled platen positioned on the protruding end, to extend the temperature controlled platen into the mold cavity. This lead screw is driven by an electric drive mechanism such as a stepper motor. This electric drive mechanism would position the temperature controlled platen by monitoring the number of partial and complete revolutions taken on the lead screw.

This preferred embodiment would be for the melt nozzle to extend to seal with and fill the mold then retract when the filling sequence is complete. A shut-off valve configured in the outlet of said nozzle permits a runnerless product configuration. This runnerless option will reduce the quantity of thermoplastic material which must be reprocessed. It also reduces the amount of secondary operations required to produce a salable product.

This temperature controlled platen provides controllable backpressure inside the mold cavity during the filling process. This backpressure will minimize molding voids in the finished product, and insure complete filling of the mold. It also cools and solidifies the leading end of the molded products during the mold filling sequence. Product coding information may be imprinted on the finished product via embossing information arranged on the product contact surface of the temperature controlled platen. When the mold has been filled, this melt valve is closed, the temperature controlled platen is retracted, the mold is released by nozzle attachment mechanism and the carousel indexes the next mold to its correct filling position.

When the melt valve is closed, the thermoplastic melt is forced into the melt accumulator, while the extruder continues to produce extrudate. This extrudate is stored in the melt accumulator until the melt valve is opened. When the next empty mold is aligned in its correct filling position, and drawn tightly to the filling nozzle, the melt valve is opened and the thermoplastic melt in the melt accumulator is forced into the melt stream from the extruder, and out through the melt valve and filling nozzle into the mold.

When one mold is aligned, and in the process of being filled, another mold, which was previously filled and has gone completely through the cooling cycle, is aligned with a platen in another index station. This platen, which is attached to an air or hydraulic cylinder, is used to push the finished product longitudinally out of the mold. Finally, the finished product is pushed longitudinally out of the mold, preferably onto a conveyor or other transport device, which moves the finished product away from the molding system.

Alternatively, dual nozzles can be used in connection with this embodiment to inject multiple layers of polymer into the mold cavities. This technique enables the utilization of lower cost, or reduced density compounds in the center or inner layers to reduce total material costs. This is accomplished via the introduction of polymer through concentric nozzles. Different extruders feed each of these nozzle orifices. These extruders can use similar or dissimilar polymers with similar or dissimilar fillers in similar or dissimilar loadings. It is preferable for the flow from the nozzles feeding the center or inner layers to start after flow feeding the outer (shell) nozzle feeding layer has started, and to stop before the nozzle feeding the shell layer stops. This arrangement will create end segments, which are consistent with the longitudinal outer (shell) surfaces. Additionally, duel nozzles may inject the same or different resin in order to more quickly fill the molds.

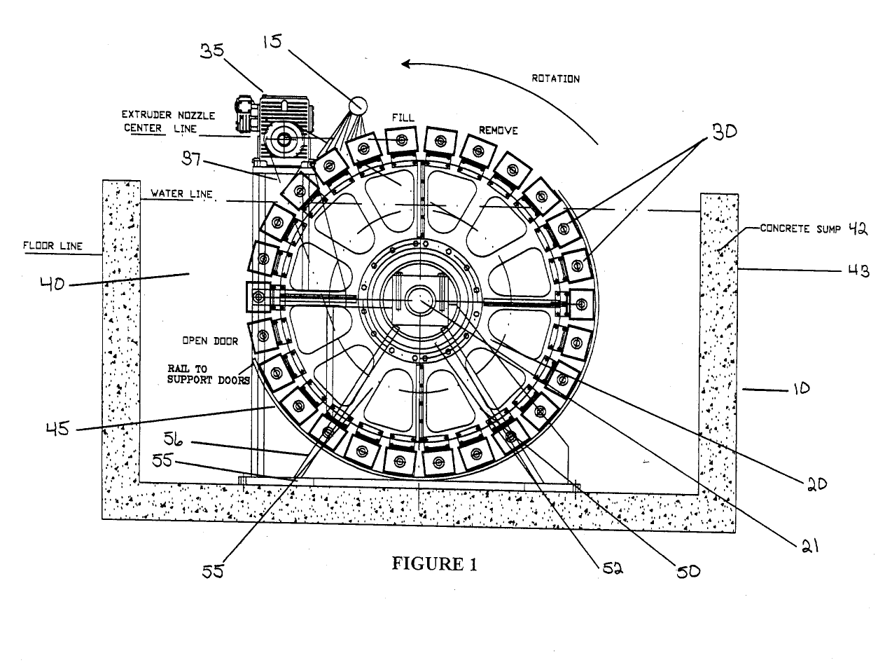

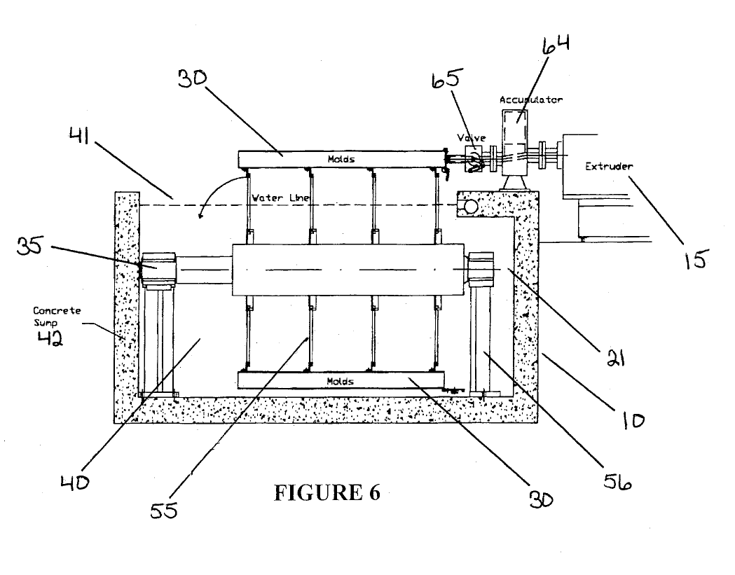

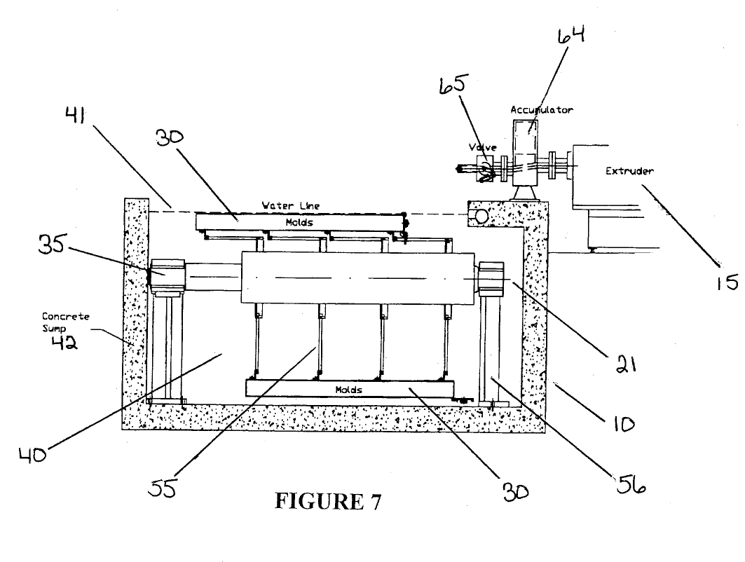

Now turning to the drawings (the reference numbers are consistent throughout all the figures), FIG. 1 shows a preferred embodiment of the present invention. In this embodiment, a cycleable molding apparatus 10 is shown that comprises an extruder 15 and a mold assembly carousel 20. The mold assembly carousel of this embodiment rotates about its axis 21 in a substantially vertical plane and is capable of indexing mold assemblies 30 to a point or station where they can be injected with a moldable thermoplastic resin composition cooled by a water bath, and removed from the apparatus. The water may be cooled to assist the curing or solidifying process. Preferably, the cooling water enters the molds as the composites shrink to help maintain composite shape and surface quality. The carousel is rotated using a standard drive mechanism or motor 35 that drives a belt 37. The motor may be manually or computer controlled to index the mold assemblies to the proper positions during the process. In the embodiment shown, the cooling station comprises a water bath 40 that partially submerges the molding apparatus. III this embodiment, approximately 75% of the apparatus is below a water line 41. The water line is held by a concrete Sump 42 that may be below a floor line 43. In this embodiment tile carousel is substantially circular shaped. In alternative embodiments the assembly carousel may be more oval-shaped. In embodiments Such as the one depicted in FIGS. 6 and 7, the shape of the circumference will change as the individual molds or groups of molds are lifted and/or retracted.

Furthermore, in this embodiment the mold assemblies are filled with resin and rotated about the periphery of the carousel. In the lower half of the rotation there is a rail to support the doors and/or the molding assembly of the present invention.

Additionally, the carousel of this embodiment has an outer circumference 50, an inner circumference 52 and support spokes 55 connecting the inner and outer circumferences. These spokes or Supports may be foldable or retractable to keep the mold assembly under the water line for a longer period during the rotation. Preferably, the retraction distance is sufficient to allow the mold assembly to remain under the water except when being indexed to a station that requires the assembly to be above water, Such as the injection station and the removal station.

Preferably, the cycleable molding apparatus has a base 55 and various Support beams 56.

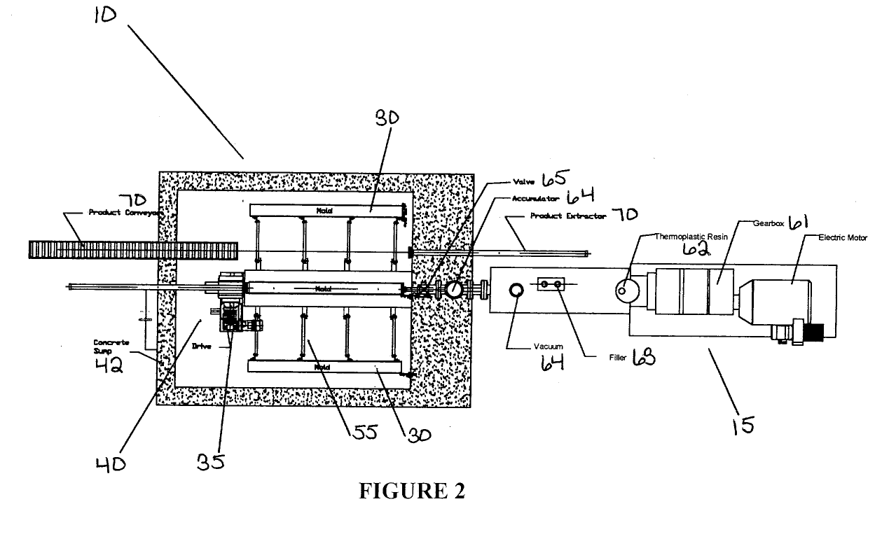

FIG. 2 shows a top view of the embodiment of FIG. 1. This figure shows a single extruder 15 with a motor 60 to drive the gearbox 61. A preferred extruder is a model 75A twin-screw compounding extruder available from Berstorff Corp, Florence, Ky. The extruder depicted comprises a thermoplastic resin container 62 and a filler container 63 although the filler and resin may be admixed earlier. This extruder has a vacuum 64 to assist in delivering the resin into the molds 30. In embodiments where the extruder is constantly extruding a resin melt, the resin melt may be stored in an accumulator 64 while the molds are being indexed into the proper position at the injection station. A valve 65 helps provide a proper connection to deliver the melt flow into the flow. This drawings additionally shows an extraction device 70 to the present invention. In this embodiment, an extendable and retractable product extractor 70 extends to pus the cooled composite from the mold onto a product conveyor 71.

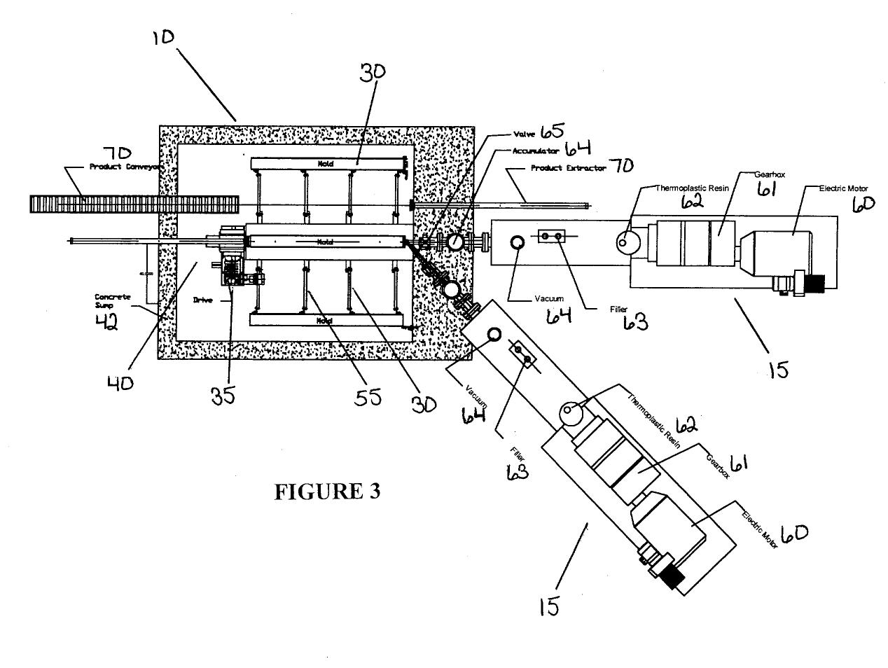

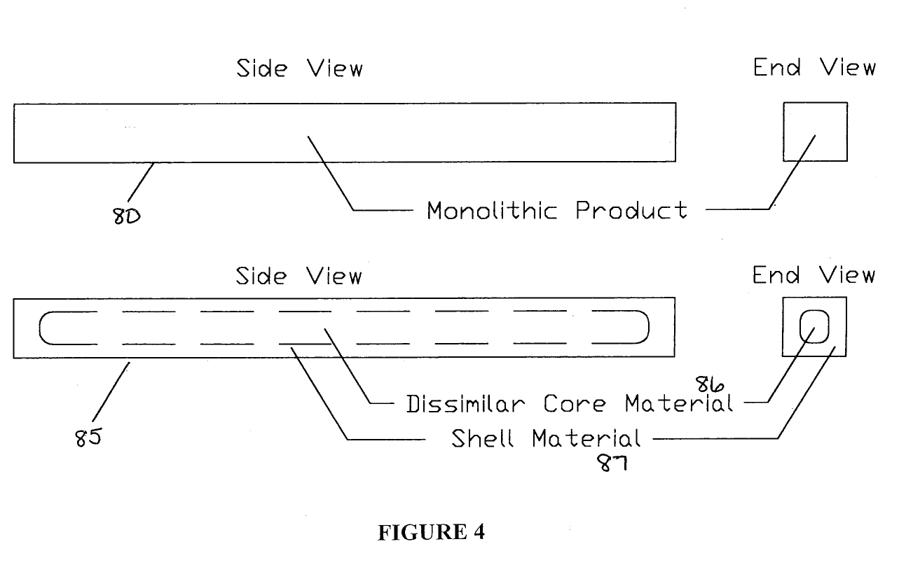

FIG. 3 shows an additional embodiment of the present invention wherein the molding apparatus comprises more than one extruder. Multiple extruders may be used to more quickly fill a mold to obtain a monolithic product as shown in FIG. 4. In other embodiments, a first extruder may extrude a first material into the mold followed by the second extruder extruding a second material into the mold. This may produce an elongated composite with a core-sheath or core-shell arrangement as depicted in FIG. 4. Depending on the various cooling characteristics of the composite, the core may be extruded in one pass then cooled. During a second pass the shell may be extruded and then cooled to form a composite with a core/sheath arrangement. Upon the second pass, the product may be ejected from the molding apparatus.

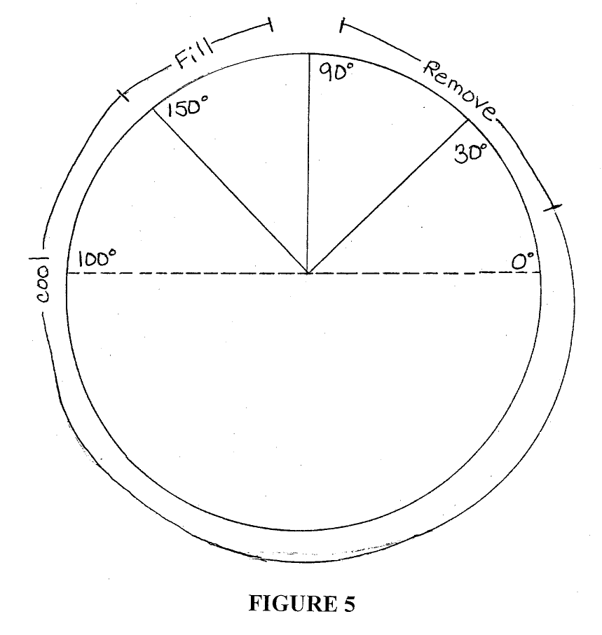

FIG. 5 demonstrates a typical cycle with respect to a preferred embodiment of the present invention.

FIGS. 6 and 7 show an embodiment where the supports 55 or spokes are foldable or retractable to keep the mold assembly under the water line for a longer period during the rotation. Preferably, the retraction distance is sufficient to allow the mold assembly to remain under the water except when being indexed to a station that requires the assembly to be above water, Such as the injection station and the removal station. Additionally, this feature may be advantageous where sufficient cooling time would require more than one rotation. FIG. 6 shows a mold assembly in an extended position and being indexed to the injection station. FIG. 7 shows the mold assembly in a retracted position below the water line 41. There are many ways apparent to one of ordinary skill in the art to provide this extension feature. For example, the support spoke may be a pneumatic cylinder that is extendable and retractable. Additionally, a drive mechanism and a track may be used.

The present invention can advantageously be used to produce railroad cross ties of various sizes and dimensions. For example, the cross ties of U.S. Pat. No. 5,886,708 may be made using the process and apparatus of the present invention.

Preferably, this invention will provide solid profiles suitable for use as railroad ties that are about 7 inches thick by about 9 inches wide by about 8-9 feet long. These profiles weigh about 250 to about 300 pounds.

Additionally pilings (e.g., marine pilings), architectural columns, bridge timber, highway guardrails, highway guardrail posts, utility poles may be made using the process and apparatus of the present invention. Furthermore, the composites may be used as dimensional lumber may also be made. Examples include deck lumber, fence lumber, deck posts, landscaping timbers, and fence posts. Measurements of these examples typically range from about 1 to 6 inches in thickness and about 3 to 12 inches in width. Additionally, the composites may be used as house or building siding and trim members, framing lumbers (specifically including studs, joists, rafters, sub-flooring, etc.).

The resin compositions used in connection with the method and apparatus of the present invention may comprise fillers. The nature of the fillers is not known to be critical as long as the fillers do no adversely affect the durability and performance of the composites of the present invention. The fillers may be reinforcement fillers such as calcium sulfate, calcium carbonate, fiberglass, talc and/or metal fibers. The fillers may also be inert diluents added to the polymeric material to reduce costs. Additionally, the fillers maybe wood flour (i.e., wood fiber) the cellulosic fibers.

Typically, fillers may be present in the amount (by weight) of from 40-70%. Preferably, fillers are present in the amount of from 50-60%. More preferably, fillers may be present in an amount of from 55 to 60%.

Finally, the composites of the present invention may incorporate other additives such as pigments, dyes, and antioxidants, ultraviolet light stabilizers, flame retardants (such as halogenated flame retardants), slip agents, nucleating agents, mold releases, etc., and combinations thereof. The additivies may be present in amounts ranging from about 0.1% to about 5%.

An embodiment of the present invention is an elongated thermoplastic composite extrusion, comprised of. (a) about 30% to about 95% of a reclaimed thermoplastic resin selected from the group consisting of low-density polyethylene, high-density polyethylene, liner polyethylene, polypropylene, and blends thereof, and (b) about 5% to about 60% by weight of a talc or talc blend filler.

As stated above, the thermoplastic resin that can be used with the present invention is not specifically limited. As one of ordinary skill in the art would understand, in embodiments where recycled or reclaimed polymers are used, the makeup of the resin would greatly vary.

As an example, the resin of the present invention may be the thermoplastic resin disclosed in U.S. Pat. No. 5,013,773, incorporated herein by reference. That is, the thermoplastic resin may include, for example, polyolefins, polyvinyl chloride, polystyrene, acrylic resin, ABS resin, nylon, polycarbonate, and thermoplastic polyester. These thermoplastic resins may be homopolymers, copolymers, or mixtures of two or more thermoplastic resins. Polyolefins are preferable among the above-mentioned thermoplastic resins.

Examples of the polyolefins include polyethylene (such as high-density polyethylene, medium-density polyethylene, low-density polyethylene, and linear low-density polyethylene), polypropylene, and polybutene. All of the above polymers may be used individually or in combination with one another.

In a preferred embodiment, the thermoplastic composition may comprises polyolefin polymers. The polyolefin polymers of this embodiment specifically include polymers of monoolefins and diolefins, for example polypropylene, polyisobutylene, polybutene-1, polymethylpentene-1, polyisoprene or polybutadiene, as well as polymers of cycloolefins, for instance of cyclopentene or norbornene, polyethylene, for example high density polyethylene, low density polyethylene and linear low density polyethylene may be used. Mixtures of these polymers, for example mixtures of polypropylene with polyethylene and mixtures of different types of polyethylene, may also be used. Also useful are copolymers of monoolefins and diolefins with each other or with other vinyl monomers, Such as, for example, ethylene/propylene, linear low density polyethylene and its mixtures with low density polyethylene, propylene/butene-1, ethylene/hexene, ethylene/ethylpentene, ethylene/heptene, ethylene/octene, propylene/isobutylene, ethylene/butane-1, propylene/butadiene, isobutylene/isoprene, ethylene/alkylacrylates, ethylene/alkyl methacrylates, ethylene/vinyl acetate or ethylene/acrylic acid copolymers and salts thereof and terpolymers of ethylene with propylene and a diene, such as hexadiene, dicyclopentadiene or ethylidene-norbornene, as well as mixtures of such copolymers and their mixtures with polymers mentioned above, or example polypropylene/ethylene-propylene-copolymers, low density polyethylene/ethylene vinyl acetate. Also suitable are polyvinyl chlorides.

Preferably, the thermoplastic resin selected from the group consisting of low-density polyethylene, high-density polyethylene, liner polyethylene, polypropylene, and blends thereof.

While virgin resins perform well in connection with the present invention, the thermoplastic resin is preferably recycled, reclaimed, or “waste” thermoplastic resin. Polymeric materials are additionally not readily biodegradable. This long lifespan is however also one of the more negative aspects incumbent with the use of polymers. The fact that a very large proportion of polymers and in particular polyolefins are used in disposable or short-lived applications necessitates that a considerable amount of waste polymer is generated shortly after it is produced. A more effective long term solution to the growing volume of waste polymer, particularly polyolefins, would be to utilize the waste plastic as a component in construction materials that require a relatively long lifespan.

The recycled thermoplastic resin of the present invention may be the “waste polyolefins” described in U.S. Pat. No. 5,886,708, incorporated herein by reference.

In a preferred embodiment, the thermoplastic composite extrusion of the present invention has a reclaimed thermoplastic resin content of from about 30% to about 70% by weight. When the resin content is less than about 30%, the composition is poor in impact resistance, nail or rail spike penetration, and surface properties. When the resin content is greater than about 70%, the composite becomes poorer in stiffness, undesirable in some uses of the composite.

The resulting composites have many uses, as would be understood by one of ordinary skill in the art. For example, preferred embodiments of the composites of the present invention are railroad cross ties. In this embodiment, the composites may be (specs on cross ties).

In other embodiments of the present invention, the composites may have various uses such as various types of pilings (e.g., marine pilings), architectural columns, bridge timber, highway guardrails, highway guardrail posts, utility poles.

Furthermore, the composites may be used as dimensional lumber. Examples include deck lumber, fence lumber, deck posts, landscaping timbers, and fence posts. Measurements of these example can range from about 1 inches to about 10 inches thick and about 3 inches to about 12 inches wide.

Additionally, the composites may be used as house or building siding and trim members, framing lumbers (specifically including studs, joists, rafters, subflooring, etc.).

Two specific composites that can be produced by the method and apparatus of the present invention include the thermoplastic railroad tie of U.S. Pat. No. 5,799,870 and the thermoplastic piling of U.S. Pat. No. 6,001,491. As stated above, the railroad tie of the '870 patent is a useful replacement for wood products and has several physical property advantages over the wood products as well as being made from recycled plastic and waste by product filler. The marine piling of the '491 patent is a useful replacement for wood pilings and has several physical property advantages and is also made from recycled plastics and waste by-product fillers.

Additionally, the composites of U.S. Pat. Nos. 5,609,295 and 5,799,870 may be produced using the methods of the present invention.

### EXAMPLES

The following examples are provided to better illustrate the present invention. The examples are for illustrative purposes only and are not intended to limit the scope of the invention in any way.

Example 1

Railroad crossties can be manufactured via this molding system using a Berstorff ZE75 co-rotating compounding extruder producing 3,000 pounds of fused thermoplastic (HDPE/talc blend) melt per hour. The melt is extruded into a mold which is 3 percent oversized to allow for shrinkage. After the mold is filled, it is immersed in a water filled sump. The water temperature in the sump would be maintained at a uniform 50 degrees Fahrenheit, and is circulated to prevent laminar flow. This production rate would result in 10 to 11 (7″×9″×8′6″) crossties per hour of operation.

### Example 2

Reclaimed thermoplastic (HDPE/LDPE/talc blend) is extruded into a 3 inch by 12 inch by 12 foot mold to produce highway guardrails. Twenty (20) molds are installed on the molding carousel. The carousel is indexed to each subsequent fill position as guardrails are removed after cooling approximately 120 minutes in the cooling sump.

The invention thus being described, it will be obvious that the same may be varied in many ways. Such variations are not regarded as a departure from the spirit and scope of the present invention, and all such modifications as would be obvious to one of ordinary skill in the art are intended to be included within the scope of the following claims.

Additionally, throughout this disclosure various patents and other publications are referenced. All patents and publications referenced herein are incorporated herein by reference in their entirety.

I claim:

1. A method of producing an elongated composite, comprising:
(1) providing a moldable thermoplastic resin composition;
(2) providing a cycleable molding apparatus, the apparatus comprising:
(i) at least one extruder,
(ii) a mold assembly carousel having an axis, inner circumference, outer circumference, and being rotateable about its axis in a substantial vertical plane and being capable of indexing a mold assembly to an injection station, cooling station, and removal station,
(iii) at least one mold assembly engaged with the outer circumference of the mold assembly carousel;
(3) injecting said moldable resin thermoplastic composition into a mold assembly with the extruder at an injection station located about the axis of the mold assembly carousel, forming an injection-filled mold assembly;
(4) rotating said mold assembly carousel about its axis, delivering said injection-filled mold assembly to a cooling station;
(5) cooling said injection-filled mold assembly at a cooling station to form an elongated composite;
(6) rotating said mold assembly about its axis, delivering the composite to a composite removal station;
(7) ejecting said composite from said mold assembly.

2. The method of claim 1, wherein said mold assembly carousel is in substantially constant rotation about its axis during progression through steps (1)-(7).

3. The method of claim 1, wherein the cooling station is a water bath.

4. The method of clam 3, wherein the mold assembly carousel is partially submersed in the water bath.

5. The method of claim 1, wherein said composite is a railroad cross tie.

6. The method of claim 1, wherein said composite is a piling.

7. The method of claim 1, wherein said composite is selected from the group consisting of dimensional lumber, house or building siding and trim members, guardrails, guardrail posts.

8. The method of claim 1, wherein the extruder provides a substantially constant melt stream during said method.

9. The method of claim 8, wherein the extruder further comprises an accumulator to receive a melt stream when a injection-filled mold assembly is being indexed to the cooling station and discharge the melt stream when the next mold assembly is in proper position for injection.

10. The method of claim 1, wherein said thermoplastic resin composition comprises a polyolefin, polyvinyl chloride, polystyrene, acrylic resin, nylon, polycarbonate, thermoplastic polyester, and combinations and blends thereof.

11. The method of claim 10, wherein said resin comprises recycled thermoplastic resin.

12. The method of claim 10, wherein said resin comprises at least one of a filler or additive.

13. The method of claim 1, wherein said mold assembly carousel is substantially circular and has support spokes connecting the inner and outer circumferences.

14. The method of claim 1, wherein said mold assembly carousel is substantially oval.

15. The method of claim 1, wherein said mold assembly comprises an extendable and retractable pneumatic cylinder to assist in ejecting said composite from said mold assembly.

16. The method of claim 1, wherein said cycleable molding apparatus is housed in, and partially submerged in, a sump that comprises cooling water.

17. The method of claim 1, wherein the removal station further comprises a roller conveyor to transport the composite away from the cycleable molding apparatus.

18. The method of claim 1, wherein the cycleable molding apparatus comprises two extruders injecting the same or different resin compositions into each mold assembly.

19. The method of claim 1, wherein the cycleable molding apparatus comprises two extruders injecting the same or different resin compositions into each mold in a sheath/core arrangement.

20. The method of claim 1, wherein the cycleable molding apparatus comprises a first and second extruder, and the first extruder injects said moldable resin composition into a mold assembly, and the second extruder injects a same or different moldable resin composition into the mold assembly on a second pass to the injection and cooling stations, and step (7) occurs after the second pass through the cooling station.

21. An injection molding apparatus, comprising:
a cycleable molding apparatus, the apparatus comprising:
(i) at least one extruder to inject a moldable resin composition into a mold assembly;
(ii) a mold assembly carousel having an axis, inner circumference, outer circumference, and being rotateable about its axis in a substantial vertical plane and being capable of indexing a mold assembly about the outer circumference;
(iii) at least one mold assembly engaged with the outer circumference of the mold assembly carousel; and
(iv) a water bath that submerses the mold assembly for a period of time an causes the moldable resin composition to solidify into a solidified extrusion material.

22. The injection molding apparatus of claim 21, wherein two extruders inject the same or different moldable resin composition into a mold assembly.

23. The injection molding apparatus of claim 21, wherein the cycleable molding device further comprises an ejection device for removing the solidified extrusion material.

24. The injection molding apparatus of claim 23, wherein the ejection devices comprises an extendable and retractable pneumatic cylinder.

25. The injection molding apparatus of claim 21, wherein the mold assembly carousel is partially submerged in the water bath.

26. The injection molding apparatus of claim 21, wherein the mold assembly carousel engages at least 10 mold assemblies.

27. The injection molding apparatus of claim 21, wherein the mold assembly carousel is in constant rotation during an molding operation.

28. The injection molding apparatus of claim 21, wherein the mold assembly carousel rotates intermittently during an molding operation.

29. The injection molding apparatus of claim 21, wherein the mold assembly carousel is substantially circular-shaped.

30. The injection molding apparatus of claim 21, wherein the mold assembly carousel is substantially oval-shaped.

31. The injection molding assembly of claim 21, wherein the mold assembly forms a railroad cross tie.

32. An injection molding apparatus, comprising:
a rotatable member with an axis and a periphery;
a plurality of mold assemblies disposed around the periphery of the rotatable member;
at least one resin melt injection extruder with at least one injection nozzle that is receivable by a mold assembly;
a water bath that intersects the mold assemblies during a rotating cycle of the rotatable member;
an ejection device that removes the solidified extruded material.

33. The injection molding apparatus of claim 32, wherein said rotatable member is rotates in a substantially vertical plane.

34. The injection molding apparatus of claim 32, wherein the totatable member is a substantially circular carousel.

35. The injection molding apparatus of claim 32, wherein said extruder comprises at least two injection nozzles.

36. The injection molding apparatus of claim 32, wherein the cycleable molding apparatus comprises two resin melt injection extruders.

37. The injection molding apparatus of claim 32, wherein the apparatus comprises at least 10 mold assemblies.

38. The injection molding apparatus of claim 32, wherein the ejection device comprises an extendable and retractable cylinder to push the solidified extruded material out of the mold.

39. The injection molding apparatus of claim 32, wherein the solidified extruded material is a railroad cross tie.

40. The injection molding apparatus of claim 32, wherein the solidified extruded material is a dimensional lumber.

41. The injection molding apparatus of claim 32, wherein the solidified extruded material is a piling.

42. A method for continuous injection molding of composites, comprising:
providing an moldable thermoplastic resin composition;
providing an injection molding apparatus, comprising:
a rotatable member with an axis and a periphery,
a plurality of mold assemblies disposed around the periphery of the rotatable member,
at least one resin melt injection extruder with at least one injection nozzle that is receivable by a mold assembly,
a water bath that intersects the mold assemblies during a rotating cycle of the rotatable member,
an ejection device that removes the solidified extruded material;
injecting the moldable thermoplastic resin composition into a mold assembly;
rotating the rotatable to transport the mold assembly through a water bath to form a solidified extruded material;
ejecting the solidified extruded material from the molding apparatus.

45. The method of claim 44, wherein said rotating step rotates the rotatable member in a substantially verticle plane.

46. The method of claim 44, where said rotatable member rotates as a substantially constantly pace during the injection, rotating, and ejection steps.

47. The method of claim 44, wherein at least 10 mold assemblies are disposed around the periphery of the rotatable member.

48. The method of claim 44, wherein said solidified extruded material is a railroad cross tie.

49. The method of claim 44, wherein said solidified extruded material is a dimensional lumber.

50. The method of claim 44, wherein said solidified extruded material is a piling.
